(19) United States
(12) Patent Application Publication
(10) Pub. No.: US 2025/0253791 A1
(43) Pub. Date: Aug. 7, 2025

(54) VARIABLE CSCR MOTOR SOFT STARTER

(71) Applicant: Micro-Air, LLC, Allentown, NJ (US)

(72) Inventors: Matteo Giovanetti, Pompano Beach, FL (US); Andrew Spaziani, Allentown, NJ (US)

(21) Appl. No.: 18/829,882

(22) Filed: Sep. 10, 2024

Related U.S. Application Data
(60) Provisional application No. 63/550,254, filed on Feb. 6, 2024.

(51) Int. Cl. H02P 25/04; H02P 1/04; H02P 23/14

(52) U.S. Cl. CPC H02P 25/04; H02P 1/04; H02P 23/14

(57) ABSTRACT

The present disclosure provides a soft start system and method for use with an electric motor. Such system may include, a parameter circuit configured to measure parameters of the electric motor, a series of capacitors, and a startup circuit operatively connected to the parameter circuit and the series of capacitors, wherein, the parameter circuit is configured to measure parameters of the electric motor during trial startup operations and determine a startup acceleration ramp based on the measured parameters, and wherein, the startup circuit is configured to activate and deactivate specific capacitors from the series of capacitors during subsequent startup operations.

### CROSS REFERENCE TO RELATED APPLICATIONS

This application claims priority to U.S. Provisional Application No. 63/550,254, filed Feb. 6, 2024, the contents of which are hereby incorporated by reference in their entirety.

### TECHNICAL FIELD

The present disclosure relates to capacitor start, capacitor run (CSCR) type motors. In particular, the present disclosure relates to an adaptive soft starter for CSCR type motors.

### BACKGROUND

The proper pairing of a soft starter to a CSCR type motor is critical for efficient operation. The primary issue is that fixed-size motor start capacitors will deliver a fixed amount of start winding excitation, and thus will only provide efficient operation to a limited range of compressor capacities. A manufacturer is often required to provide a wide range of different model variants in order to cover the full range of compressor capacities. The present disclosure provides an adaptive soft starter capable of providing multiple different levels of start winding excitation using a series of individually controlled start capacitor banks.

### SUMMARY

The present disclosure provides, in one aspect, adaptive start systems for an electric motor, comprising a plurality of capacitive elements, a switching arrangement configured to selectively activate and deactivate each of the plurality of capacitive elements, and a control system configured to collect motor operational data during multiple start operations, determine excitation parameters based on the collected operational data, control a start operation by selectively activating one or more of the capacitive elements based on the determined excitation parameters, and dynamically adjust the activation of the capacitive elements during the start operation based on motor conditions.

In some embodiments, the electric motor is a capacitor start, capacitor run (CSCR) motor.

In some embodiments, the capacitive elements are start capacitor banks (SCBs).

In some embodiments, the control system is further configured to store optimal activation settings for subsequent start operations.

In some embodiments, the switching arrangement comprises solid-state switching devices.

In some embodiments, the solid-state switching devices comprise Silicon-controlled Rectifier (SCR) devices and opto-coupler triggering devices.

In some embodiments, each capacitive element comprises two opposed, series polarized capacitors and discharge resistors for each capacitor.

In some embodiments, the system further comprises one or more sensors configured to provide feedback to the control system, the sensors including one or more of current sensors, voltage sensors, speed sensors, temperature sensors, and vibration sensors.

In some embodiments, the control system is further configured to gradually reduce the number of activated capacitive elements during the start operation.

In some embodiments, the system further comprises a protection circuit configured to prevent damage to the motor or capacitive elements in case of abnormal conditions.

In some embodiments, the protection circuit includes self-diagnostic capabilities to detect and report potential issues with the system or motor.

In some embodiments, the system further comprises a user interface for adjustment of start parameters and for displaying system status.

In some embodiments, the system further comprises a communication interface configured to allow remote monitoring and adjustment of start parameters.

In some embodiments, the system further comprises an energy monitoring module configured to track efficiency improvements provided by the adaptive start system.

In some embodiments, the system further comprises an analytics module configured to predict potential issues based on trends in motor performance data over time.

The present disclosure provides, in another aspect, methods for adaptive starting of an electric motor, comprising collecting motor operational data during multiple start operations, determining excitation parameters based on the collected operational data, controlling a start operation by selectively activating one or more capacitive elements based on the determined excitation parameters, and dynamically adjusting the activation of the capacitive elements during the start operation based on motor conditions.

In some embodiments, the method further comprises gradually reducing the number of activated capacitive elements during the start operation.

In some embodiments, the method further comprises detecting abnormal conditions and protecting the motor and capacitive elements from damage.

In some embodiments, the method further comprises monitoring energy consumption and generating reports on energy savings provided by the adaptive start method.

The present disclosure provided, in yet another aspect, control systems for an adaptive start system for an electric motor, the control system configured to collect motor operational data during multiple start operations, determine excitation parameters based on the collected operational data, control a start operation by selectively activating one or more capacitive elements based on the determined excitation parameters, and dynamically adjust the activation of the capacitive elements during the start operation based on motor conditions.

Other aspects of the disclosure will become apparent by consideration of the detailed description and accompanying drawings.

### Definitions

The terms “substantially” or “generally” are used to provide flexibility by recognizing that a given characteristic need not be perfectly embodied to have the desired result. Those of ordinary skill in the art will recognize that many characteristics described herein may be essentially present without strict adherence to the characteristic's definition.

The term “coupled,” as used herein, is defined as “connected,” although not necessarily directly, and not necessarily mechanically. The term coupled is to be understood to mean physically, magnetically, chemically, fluidly, electrically, or otherwise coupled, connected or linked and does not exclude the presence of intermediate elements between the coupled elements absent specific contrary language.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “an” and “the” include plural references unless the context clearly dictates otherwise. The present disclosure also contemplates other embodiments “comprising,” “consisting of” and “consisting essentially of,” the embodiments or elements presented herein, whether explicitly set forth or not.

As used herein, a “system” refers to a plurality of real and/or abstract components operating together for a common purpose. In some embodiments, a “system” is an integrated assemblage of hardware and/or software components. In some embodiments, each component of the system interacts with one or more other components and/or is related to one or more other components. In some embodiments, a system refers to a combination of components and software for controlling and directing methods.

Suitable software for implementing various components of example systems and methods described herein may be developed using programming languages and tools (e.g., Java, C, C#, C++, C, SQL, APIs, SDKs, Swift, NEXTStep, SmallTalk, Unix, Objective C, assembler). Software, whether an entire system or a component of a system, may be embodied as an article of manufacture and maintained or provided as part of a computer-readable medium. Software may include signals that transmit program code to a recipient over a network or other communication medium. Thus, in one example, a computer-readable medium may be signals that represent software/firmware as it is downloaded from a server (e.g., web server).

A “connection” by which two components of a system, e.g., an electrical system, a data system, a computer system, a circuitry system, etc., are connected will generally be an “operable connection”, or a connection by which entities are “operably connected”. The term “operable connection” and equivalents is one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other directly or through one or more intermediate entities (e.g., processor, operating system, logic, software). Logical and/or physical communication channels can be used to create an operable connection.

The term “circuit” as used herein generally refers to a complete circular path of conductive material that electricity flows through, and may include any number, combination and arrangement of electrical components, including, resistors, capacitors, inductors, diodes, LEDs, transistors, crystals and oscillators, electromechanical components like relays and switches, ICs, and connectors, among others.

As used herein the terms “memory” generally refer to a physical and/or logical entity that can store data, e.g., any memory storage of a computer and is a non-transitory computer readable medium. A data store may be, for example, a database, a table, a file, a list, a queue, a heap, a memory, a register, and so on. A data store may reside in one logical and/or physical entity and/or may be distributed between multiple logical and/or physical entities. Software included in the implementation of the methods disclosed herein can be stored in the memory. The software includes, for example, firmware, one or more applications, program data, filters, rules, one or more program modules, and other executable instructions. For example, the computer can be configured to retrieve from the memory and execute, among other things, instructions related to the processes and methods described herein.

In the foregoing description of preferred embodiments, specific terminology has been resorted to for the sake of clarity. However, the present disclosure is not intended to be limited to the specific terms so selected, and it is to be understood that each specific term includes all technical equivalents which operate in a similar manner to accomplish a similar technical purpose.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing of the present disclosure. All publications, patent applications, patents and other references mentioned herein are incorporated by reference in their entirety. The materials, methods, and examples disclosed herein are illustrative only and not intended to be limiting.

### BRIEF DESCRIPTION OF THE DRAWINGS

FIG. 1 is a representative schematic of a circuit is shown that is capable of activating or deactivating specific start capacitor banks (SCBs) during a CSCR motor startup operation.

FIG. 2 is a representative schematic of a circuit containing multiple capacitor banks capable of being activated or deactivated by the circuit of FIG. 1.

FIG. 3 is a flow chart illustrating a representative method of an adaptive soft start of a CSCR electric motor in accordance with the present disclosure.

Before any embodiments are explained in detail, it is to be understood that the present disclosure is not limited in its application to the details of construction and the arrangement of components set forth in the following description or illustrated in the accompanying drawings. The present disclosure is capable of other embodiments and of being practiced or of being carried out in various ways.

### DETAILED DESCRIPTION

Capacitor start, capacitor run (CSCR) motors are a type of electric motors used in a wide range of applications (e.g. compressors, pumps, etc.), and are defined by their implementation of two separate capacitors during operation. In general, during the starting phase, a larger electrolytic capacitor is used to provide the initial boost of power needed to overcome the inertia and start the motor. This capacitor is known as the start capacitor. The start capacitor may be a single capacitor or a bank of capacitors connected in parallel or series-parallel combinations to achieve the desired capacitance and voltage rating.

Once the motor reaches a certain speed, typically 75% to 80% of its rated speed, a switch disconnects the start capacitor from the circuit to prevent damage or overheating. This switch may be a centrifugal switch mounted on the motor shaft, a current-sensing relay, or an electronic switch controlled by a microprocessor. After the motor has successfully started, a smaller capacitor, called the run capacitor, remains connected to the motor circuit. The run capacitor helps enhance the motor's efficiency and power factor during continuous operation. While capacitor start, capacitor run (CSCR) motors already incorporate a mechanism for smooth starting, the use of a soft starter in conjunction with these motors eliminates the switched start capacitor and can provide additional benefits, such as further reducing the inrush current and providing a controlled acceleration during the starting phase.

The proper pairing of a soft starter to a CSCR type motor is critical for efficient operation. The present disclosure provides a system and method of utilizing multiple individual start capacitor banks with individual switching circuits to allow the dynamic and self-optimized application of start winding excitation during a soft startup sequence. This results in maximum start-up current surge reduction, smooth start-to-run transition, and continued adaptability over environmental conditions and over the life of the motor system. The system can be adapted to work with single-phase or three-phase CSCR motors of various sizes and ratings.

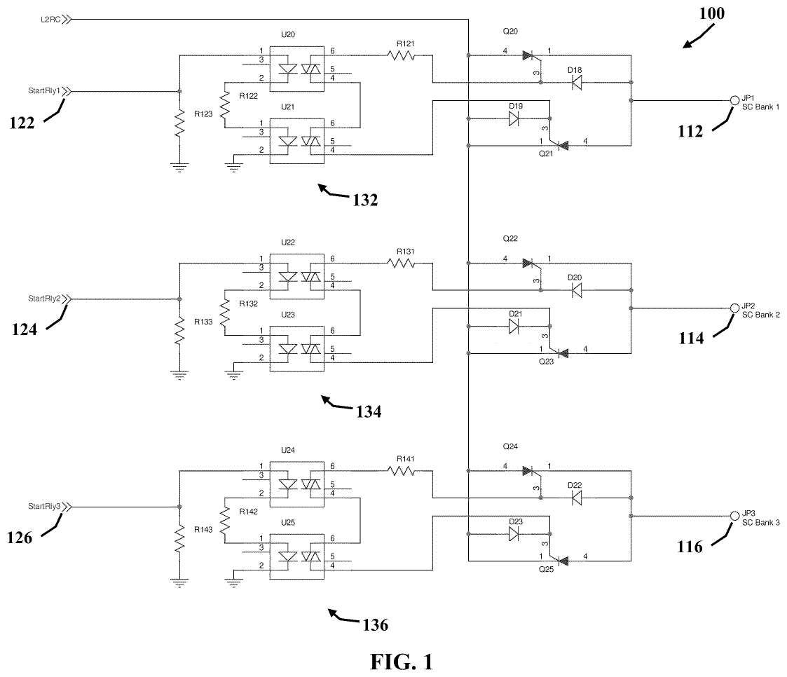

Referring to FIG. 1, a representative schematic of a circuit 100 is shown that is capable of activating or deactivating specific start capacitor banks (SCBs) 112, 114, 116 during a CSCR motor startup operation. In this particular embodiment, the circuit is capable of activating three SCBs but could be adapted to function with any number of SCBs to achieve greater granularity. The number of SCBs can range from two to ten or more, depending on the specific motor requirements and desired level of control. The electric signals labeled “StartRly1” 122, “StartRly2” 124, and “StartRly3” 126, are energized or de-energized to activate or deactivate each respective SCB. These signals may be generated by a microcontroller, a programmable logic controller (PLC), or a custom-designed control circuit. The circuit contains three identical, individual, solid-state switching banks 132, 134, 136, each corresponding to one of the three SCBs 112, 114, 116. Each switching bank employs high-voltage/high-current Silicon-controlled Rectifier (SCR) devices and high-voltage opto-coupler triggering devices, providing high isolation and resilience to switching voltages. Alternative embodiments may use other switching devices such as insulated-gate bipolar transistors (IGBTs), metal-oxide-semiconductor field-effect transistors (MOSFETs), or electromechanical relays, depending on the voltage and current requirements of the specific application.

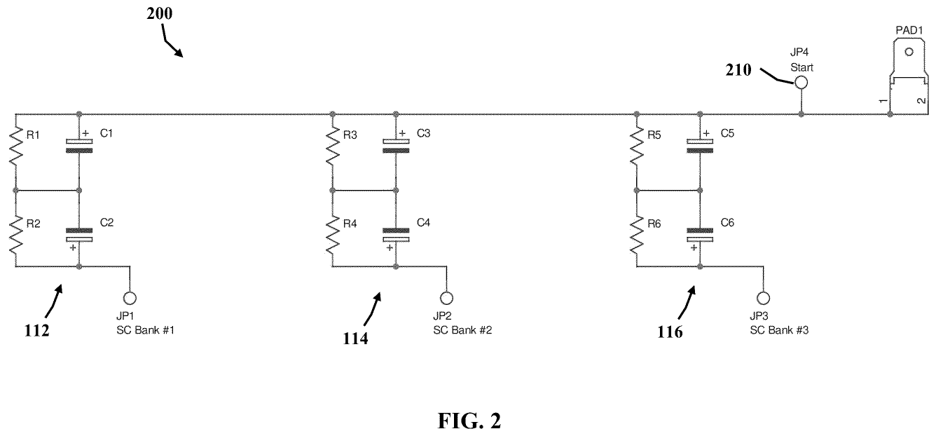

Referring to FIG. 2, a representative schematic of a circuit 200 containing multiple capacitor banks 112, 114, 116 capable of being activated or deactivated by the circuit of FIG. 1 is shown. In this particular embodiment, three SCBs are shown, but the circuit could be adapted to function with any number of SCBs. Each SCB consists of two opposed, series polarized capacitors (C1/C2, C3/C4, and C5/C6 respectively) and high-wattage bleed resistors for each capacitor (R1/R2, R3/R4, and R5/R6 respectively). This configuration provides unipolarity and greater voltage tolerance by splitting the total voltage requirement, as well as enabling rapid discharge after de-energization. Alternative embodiments may use different capacitor configurations, such as single high-voltage capacitors or parallel-series combinations, depending on the voltage rating and capacitance required. The bleed resistors may be replaced with active discharge circuits for faster capacitor discharge in some embodiments. The outputs of all three SCBs are connected together and then to the compressor motor's start winding 210. In some embodiments, the SCBs may be connected to the motor through additional components such as current-limiting reactors or soft-start thyristors to provide further control over the starting current.

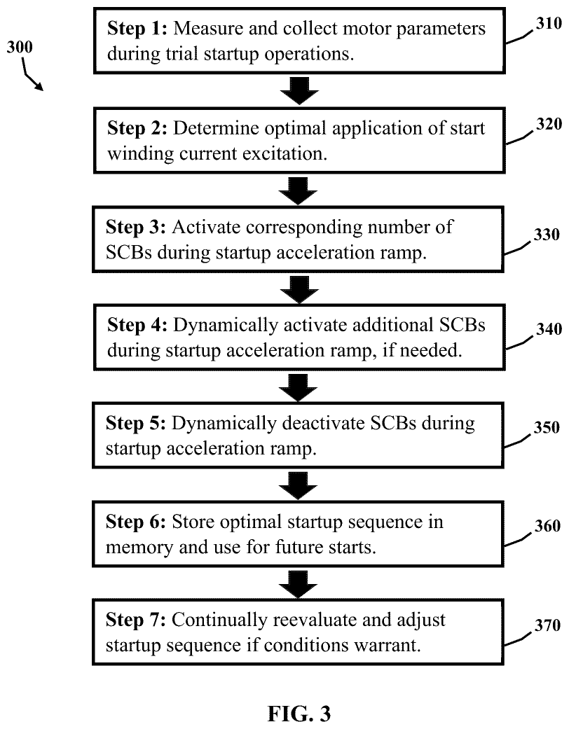

Referring to FIG. 3, a flow chart illustrating a representative method of an adaptive soft start of a CSCR electric motor is shown. During the first step, the disclosed system will measure and collect a given CSCR electric motor's parameters using feedback circuits during multiple learning soft startup operations where the motor's run winding is excited via a controlled and ramped application of voltage and current with live, real-time rotational speed and consumed-current feedback (310). The feedback circuits may include current transformers, voltage sensors, and speed sensors such as encoders or Hall effect sensors. The system may also monitor temperature, vibration, or other relevant parameters to optimize the starting process. Then, the disclosed system determines the proper level of start winding current excitation required (in parallel with the run winding excitation) based upon the parameters measured in the first step (320). This determination may involve complex algorithms that take into account factors such as motor size, load characteristics, ambient temperature, and supply voltage variations.

In the third step, the system will perform a soft start by adjusting the number of applied start capacitor banks (SCBs) in order to deliver more or less start winding excitation ultimately to orchestrate an optimal startup current reduction during the entire startup sequence (330). The adjustment of SCBs may be done in a binary fashion (on/off) or with finer granularity using techniques such as phase-angle control of the SCR switches. Also, during the soft start sequence, the system will dynamically apply additional SCBs if motor conditions suddenly change and require more start winding excitation to accomplish the start (340). This dynamic adjustment may be based on real-time monitoring of motor current, speed, or other relevant parameters. The system then dynamically sheds the number of applied SCBs during the startup acceleration ramp in order to minimize transients during start-to-run transition, optimizing the points (i.e. rotational speeds) at which each applied SCB is disconnected (350). The shedding process may be based on a predetermined schedule or dynamically adjusted based on real-time motor performance.

During the sixth step, the system stores the optimal number of SCBs for use in all subsequent startups after the learning or trial sequence completes its optimization (360). This storage may be in non-volatile memory such as EEPROM or flash memory, allowing the system to retain the optimized settings even after power loss. Finally, during subsequent startups, the system will dynamically adjust (increase) the number of applied SCBs on future startup attempts if conditions warrant (370). This adaptive behavior allows the system to compensate for changes in motor characteristics due to aging, environmental factors, or changes in the load.

The adaptive soft start system incorporates several additional features to enhance its functionality and reliability. A comprehensive fault detection and protection circuit is integrated into the system to prevent damage to the motor or SCBs in case of abnormal conditions. This circuit continuously monitors various parameters such as current, voltage, temperature, and vibration. If any of these parameters exceed predetermined thresholds, the system can quickly disconnect the motor and SCBs to prevent damage. The fault detection system also includes self-diagnostic capabilities to detect and report potential issues with the soft starter or motor, allowing for proactive maintenance and minimizing downtime.

A user interface is provided for manual adjustment of startup parameters and for displaying system status. This interface may be a local display with buttons or a touch screen, allowing operators to view real-time data, adjust settings, and review historical performance data. For more advanced applications, the system may include a communication interface (e.g., Modbus, Profibus, or Ethernet) to allow remote monitoring and adjustment of the soft start parameters. This feature enables integration with building management systems or industrial control systems for coordinated operation with other equipment.

The system also incorporates energy monitoring and reporting features to track the efficiency improvements provided by the adaptive soft start system. These features calculate and log energy consumption during motor starts and normal operation, compare it to baseline data, and generate reports on energy savings. This information can be valuable for facilities management and for justifying the investment in the adaptive soft start system.

In some embodiments, the system may include advanced analytics capabilities. By analyzing trends in motor performance data over time, the system can predict potential failures or degradation in motor efficiency. This predictive maintenance feature can alert operators to schedule maintenance before a failure occurs, further reducing downtime and maintenance costs.

The adaptive soft start system may also be designed with modular components, allowing for easy upgrades or replacements of individual parts. This modularity can extend the life of the overall system and allow for future enhancements as technology improves. Additionally, the system's firmware can be designed to be updatable, allowing for the addition of new features or improvements to the control algorithms over time.

Various features and advantages are set forth in the following claims.

What is claimed is:

1. An adaptive start system for an electric motor, comprising:
a plurality of capacitive elements;
a switching arrangement configured to selectively activate and deactivate each of the plurality of capacitive elements; and
a control system configured to:
collect motor operational data during multiple start operations;
determine excitation parameters based on the collected operational data;
control a start operation by selectively activating one or more of the capacitive elements based on the determined excitation parameters; and
dynamically adjust the activation of the capacitive elements during the start operation based on motor conditions.

2. The system of claim 1, wherein the electric motor is a capacitor start, capacitor run (CSCR) motor.

3. The system of claim 1, wherein the capacitive elements are start capacitor banks (SCBs).

4. The system of claim 1, wherein the control system is further configured to store optimal activation settings for subsequent start operations.

5. The system of claim 1, wherein the switching arrangement comprises solid-state switching devices.

6. The system of claim 5, wherein the solid-state switching devices comprise Silicon-controlled Rectifier (SCR) devices and opto-coupler triggering devices.

7. The system of claim 1, wherein each capacitive element comprises two opposed, series polarized capacitors and discharge resistors for each capacitor.

8. The system of claim 1, further comprising one or more sensors configured to provide feedback to the control system, the sensors including one or more of current sensors, voltage sensors, speed sensors, temperature sensors, and vibration sensors.

9. The system of claim 1, wherein the control system is further configured to gradually reduce the number of activated capacitive elements during the start operation.

10. The system of claim 1, further comprising a protection circuit configured to prevent damage to the motor or capacitive elements in case of abnormal conditions.

11. The system of claim 10, wherein the protection circuit includes self-diagnostic capabilities to detect and report potential issues with the system or motor.

12. The system of claim 1, further comprising a user interface for adjustment of start parameters and for displaying system status.

13. The system of claim 1, further comprising a communication interface configured to allow remote monitoring and adjustment of start parameters.

14. The system of claim 1, further comprising an energy monitoring module configured to track efficiency improvements provided by the adaptive start system.

15. The system of claim 1, further comprising an analytics module configured to predict potential issues based on trends in motor performance data over time.

16. A method for adaptive starting of an electric motor, comprising:
collecting motor operational data during multiple start operations;
determining excitation parameters based on the collected operational data;
controlling a start operation by selectively activating one or more capacitive elements based on the determined excitation parameters; and
dynamically adjusting the activation of the capacitive elements during the start operation based on motor conditions.

17. The method of claim 16, further comprising gradually reducing the number of activated capacitive elements during the start operation.

18. The method of claim 16, further comprising detecting abnormal conditions and protecting the motor and capacitive elements from damage.

19. The method of claim 16, further comprising monitoring energy consumption and generating reports on energy savings provided by the adaptive start method.

20. A control system for an adaptive start system for an electric motor, the control system configured to:
collect motor operational data during multiple start operations;
determine excitation parameters based on the collected operational data;
control a start operation by selectively activating one or more capacitive elements based on the determined excitation parameters; and
dynamically adjust the activation of the capacitive elements during the start operation based on motor conditions.
